(19) United States
(12) Patent Application Publication
(10) Pub. No.: US 2024/0175412 A1
(43) Pub. Date: May 30, 2024

(54) HYDROGEN ENGINE SYSTEM

(71) Applicants: Ryosuke YAMAMOTO, Seto-shi (JP); Toshihisa TANAKA, Toyota-shi (JP); Taichi ODA, Toyota-shi (JP)

(72) Inventors: Ryosuke YAMAMOTO, Seto-shi (JP); Toshihisa TANAKA, Toyota-shi (JP); Taichi ODA, Toyota-shi (JP)

(73) Assignees: TOYOTA JIDOSHA KABUSHIKI KAISHA, Aichi-ken (JP); Suzuki Shokan Co., Ltd., TOKYO (JP)

(21) Appl. No.: 18/518,580

(22) Filed: Nov. 23, 2023

(30) Foreign Application Priority Data
Nov. 24, 2022 (JP) 2022-187635

(51) Int. Cl. F17C 9/02

(52) U.S. Cl. CPC F17C 9/02; F17C 2221/012; F17C 2227/0316

(57) ABSTRACT

A hydrogen engine system includes: a hydrogen engine; a cooling channel through which a liquid heat medium that cools the hydrogen engine flows; and a vaporizer, disposed in the cooling channel, through which the heat medium and liquid hydrogen flow, the vaporizer causing the heat medium to vaporize the liquid hydrogen to generate hydrogen gas.

### CROSS REFERENCE TO RELATED APPLICATION

This application claims priority to Japanese Patent Application No. 2022-187635 filed on Nov. 24, 2022, which is incorporated herein by reference in its entirety including the specification, claims, drawings, and abstract.

### TECHNICAL FIELD

The present disclosure relates to a configuration of a hydrogen engine system.

### BACKGROUND

A system has been proposed that vaporizes liquid hydrogen and supplies it to an internal combustion engine. For example, JP 2021-021433 A discloses a system that exchanges heat between heated helium gas and liquid hydrogen to vaporize the liquid hydrogen.

In addition, JP 2886204 B proposes a system that includes a hydrogen engine and an expansion engine so that: the exhaust gas from the hydrogen engine heats a heat medium to drive the expansion engine; and the high-temperature exhaust gas from the expansion engine heats liquid hydrogen to form hydrogen gas that is supplied to the hydrogen engine.

### SUMMARY

Now, liquid hydrogen has an extremely low temperature. This may freeze the moisture in the heat medium for heat exchange in the system as described in JP 2886204 B, clogging the channel or decreasing the heat exchange efficiency. In contrast, in the case where helium gas is used as an intermediate heat medium as in the system described in JP 2021-021433 A, the heat medium does not freeze. However, the heat exchange with the gas disadvantageously decreases the heat exchange efficiency, resulting in a large size of the apparatus as a whole.

Therefore, it is an advantage of the present disclosure to provide a compact hydrogen engine system with a simple configuration.

The hydrogen engine system of the present disclosure is characterized by including: a hydrogen engine; a cooling channel through which a liquid heat medium that cools the hydrogen engine flows; and a vaporizer, disposed in the cooling channel, through which the heat medium and liquid hydrogen flow, the vaporizer causing the heat medium to vaporize the liquid hydrogen to generate hydrogen gas.

In this way, the liquid heat medium heats the liquid hydrogen, so that the heat exchange efficiency increases, enabling the vaporizer to be compact. This in turn enables the hydrogen engine system to be compact.

The hydrogen engine system of the present disclosure may be configured so that the heat medium is LLC or water.

Use of a general heat medium such as LLC or water can simplify the configuration of the hydrogen engine system.

The hydrogen engine system of the present disclosure may be configured so that a flow velocity of the heat medium inside the vaporizer is 26 mm/s or more.

In this way, increase in the flow velocity of the liquid heat medium can prevent freezing of the liquid heat medium.

The hydrogen engine system of the present disclosure may be configured so that a temperature difference of the heat medium between an inlet and an outlet of the vaporizer is 10° C. or less.

This configuration makes it possible to prevent the liquid heat medium from dropping in temperature, thereby preventing it from freezing.

The hydrogen engine system of the present disclosure may be configured so that the cooling channel is composed of: a first cooling channel through which a liquid first heat medium that cools the hydrogen engine flows; and a second cooling channel through which a second heat medium different from the first heat medium flows, the hydrogen engine system includes a heat exchanger, disposed across the first cooling channel and the second cooling channel, through which the first heat medium and the second heat medium flow, the heat exchanger causing the first heat medium to heat the second heat medium, and the vaporizer, through which the second heat medium and the liquid hydrogen flow, causes the second heat medium to vaporize the liquid hydrogen to generate the hydrogen gas.

A liquid first refrigerant heats a liquid second refrigerant and the heated liquid second refrigerant vaporizes hydrogen, enabling the heat exchange efficiency to increase and the vaporizer to be compact. Also, this enables the hydrogen engine system to be compact.

The hydrogen engine system of the present disclosure may further include a cooler that cools the first heat medium, wherein the first heat medium and the second heat medium are LLC or water.

This enables effectively cooling the hydrogen engine. In addition, use of a general heat medium such as LLC or water can simplify the configuration of the hydrogen engine system.

The present disclosure can provide a compact hydrogen engine system with a simple configuration.

### BRIEF DESCRIPTION OF DRAWINGS

Embodiment(s) of the present disclosure will be described based on the following figures, wherein:

FIG. 1 is a system diagram of a hydrogen engine system according to an embodiment;

FIG. 2 is a system diagram of a hydrogen engine system according to another embodiment; and

FIG. 3 is a system diagram of a hydrogen engine system according to still another embodiment.

### DESCRIPTION OF EMBODIMENTS

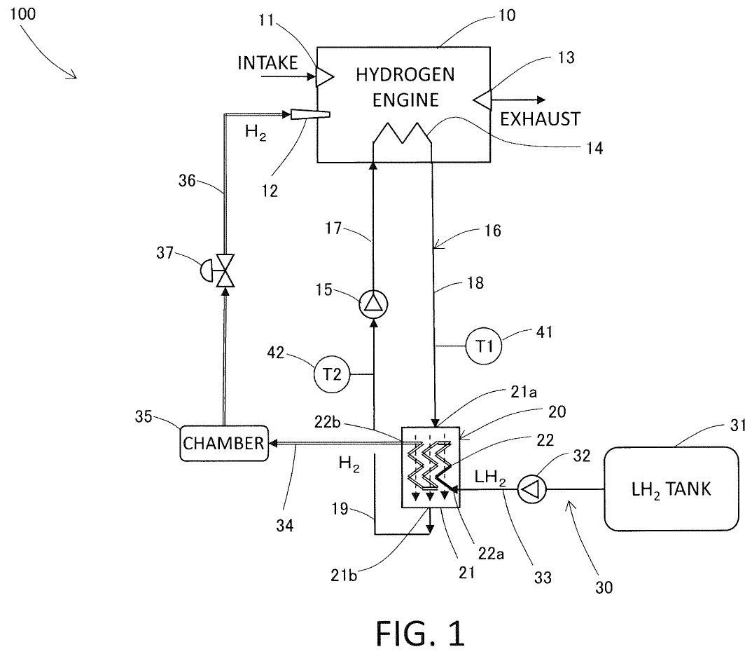

A hydrogen engine system 100 of an embodiment will be described below with reference to the drawings. As shown in FIG. 1, the hydrogen engine system 100 includes a hydrogen engine 10, a vaporizer 20, a cooling channel 16, and a hydrogen channel 30. In each figure, LH₂ indicates liquid hydrogen, and H₂ indicates hydrogen gas.

The hydrogen engine 10 includes an intake port 11 that draws in outside air, a hydrogen gas nozzle 12 to which hydrogen gas is supplied, and an exhaust port 13 that discharges exhaust gas from hydrogen gas combustion. The hydrogen engine 10 internally includes an internal cooling channel 14 through which a liquid heat medium that cools the hydrogen engine 10 flows.

The vaporizer 20, through which a heat medium and liquid hydrogen flow, causes the heat medium to vaporize the liquid hydrogen into hydrogen gas. The vaporizer 20 is composed of a casing 21, and a coil 22 attached inside the casing 21. The casing 21 is provided with a heat medium inlet 21a through which the heat medium flows in and a heat medium outlet 21b through which the heat medium flows out. The coil 22 is a pipe member made of a thin pipe formed in a spiral shape. The coil 22 has a coil inlet 22a through which liquid hydrogen flows in, and has a coil outlet 22b through which hydrogen gas flows out. The coil 22, through the inside of which liquid hydrogen and hydrogen gas flow, causes them to exchange heat with a heat medium flowing on the outer surface of the coil 22.

The cooling channel 16 is composed of a cooling water pump 15, a heat medium supply pipe 17, the internal cooling channel 14, a heat medium outlet pipe 18, the vaporizer 20, and a heat medium return pipe 19. The heat medium supply pipe 17 connects the outlet of the cooling water pump 15 and the inlet of the internal cooling channel 14 of the hydrogen engine 10. The heat medium outlet pipe 18 connects the outlet of the internal cooling channel 14 and the heat medium inlet 21a of the vaporizer 20. The heat medium return pipe 19 connects the heat medium outlet 21b of the vaporizer 20 and the inlet of the cooling water pump 15.

The hydrogen channel 30 is composed of a liquid hydrogen tank 31, a liquid hydrogen pump 32, a liquid hydrogen supply pipe 33, the coil 22 of the vaporizer 20, a hydrogen gas outlet pipe 34, a chamber 35, a hydrogen gas supply pipe 36, and a pressure reducing valve 37.

The liquid hydrogen tank 31 is a tank that stores liquid hydrogen at extremely low temperature. The liquid hydrogen supply pipe 33 connects the liquid hydrogen tank 31 and the coil inlet 22a. The liquid hydrogen supply pipe 33 has the liquid hydrogen pump 32 for pressurizing liquid hydrogen attached thereto. The hydrogen gas outlet pipe 34 connects the coil outlet 22b of the vaporizer 20 and the chamber 35. The chamber 35 stores high pressure hydrogen gas. The hydrogen gas supply pipe 36 connects the chamber 35 and the hydrogen gas nozzle 12 of the hydrogen engine 10. The hydrogen gas supply pipe 36 has the pressure reducing valve 37 for reducing the pressure of the hydrogen gas attached thereon.

The following describes the flow of the heat medium, liquid hydrogen, and hydrogen gas in the hydrogen engine system 100.

The low-temperature heat medium is pressurized by the cooling water pump 15 and flows through the heat medium supply pipe 17 into the internal cooling channel 14 of the hydrogen engine 10. When the heat medium passes through the internal cooling channel 14, it is heated by the combustion heat of the hydrogen engine 10, becomes a high-temperature heat medium, and flows out from the internal cooling channel 14 to the heat medium outlet pipe 18. Then, the heat medium flows from the heat medium outlet pipe 18 into the casing 21 through the heat medium inlet 21a of the vaporizer 20.

Meanwhile, the extremely-low-temperature liquid hydrogen, which has been stored in the liquid hydrogen tank 31, is pressurized by the liquid hydrogen pump 32 and flows from the liquid hydrogen supply pipe 33 into the coil inlet 22a of the vaporizer 20.

The high-temperature heat medium, which has flowed into the casing 21, flows on the outer surface of the coil 22. The extremely-low-temperature liquid hydrogen flows inside the coil 22. The high-temperature heat medium and liquid hydrogen exchange heat through the coil 22, the liquid hydrogen is vaporized into hydrogen gas, and the hydrogen gas flows out from the coil outlet 22b of the vaporizer 20 to the hydrogen gas outlet pipe 34. The high-temperature heat medium exchanges heat with the extremely-low-temperature liquid hydrogen flowing through the coil 22, becomes a low-temperature heat medium, and flows out from the heat medium outlet 21b to the heat medium return pipe 19.

The low-temperature heat medium, which has flowed out to the heat medium return pipe 19, flows into the cooling water pump 15, is pressurized by the cooling water pump 15, and circulates through the cooling channel 16.

Meanwhile, the high-pressure hydrogen gas, which has flowed out to the hydrogen gas outlet pipe 34, is temporarily stored in the chamber 35, is then decompressed to a pressure for supplying hydrogen to the hydrogen engine 10 by the pressure reducing valve 37, and is supplied to the combustion chamber (not shown) of the hydrogen engine 10 from the hydrogen gas nozzle 12. Exhaust gas after combustion in the combustion chamber of the hydrogen engine 10 is discharged from the exhaust port 13 to outside air.

In the hydrogen engine system 100, the heat medium to be used may be water or LLC (long life coolant).

The hydrogen engine system 100 described above causes a liquid heat medium to exchange heat with liquid hydrogen or hydrogen gas through the coil 22. Therefore, the heat exchange efficiency between the heat medium and the liquid hydrogen or the hydrogen gas increases, enabling the vaporizer 20 to be compact. This enables the hydrogen engine system 100 to be compact.

In addition, in the hydrogen engine system 100 of the embodiment, the vaporizer 20 is provided with an internal partition (not shown) that reduces the channel area through which the heat medium flows. The partition keeps the flow velocity of the heat medium flowing on the outer surface of the coil 22 at a predetermined flow velocity or higher. The predetermined flow velocity may be 26 mm/s or more, for example, when water or LLC (long life coolant) is used as the heat medium. This makes it possible to prevent the heat medium from freezing when it flows on the outer surface of the coil 22 and prevent a decrease in the heat exchange efficiency.

Further, in the hydrogen engine system 100 of the embodiment, the discharge amount of the cooling water pump 15 may be adjusted so that the temperature difference between the temperature T1 of the heat medium inlet 21a and the temperature T2 of the heat medium outlet 21b is 10° C. or less. This makes it possible to prevent the heat medium from freezing and to prevent heat exchange efficiency from decreasing.

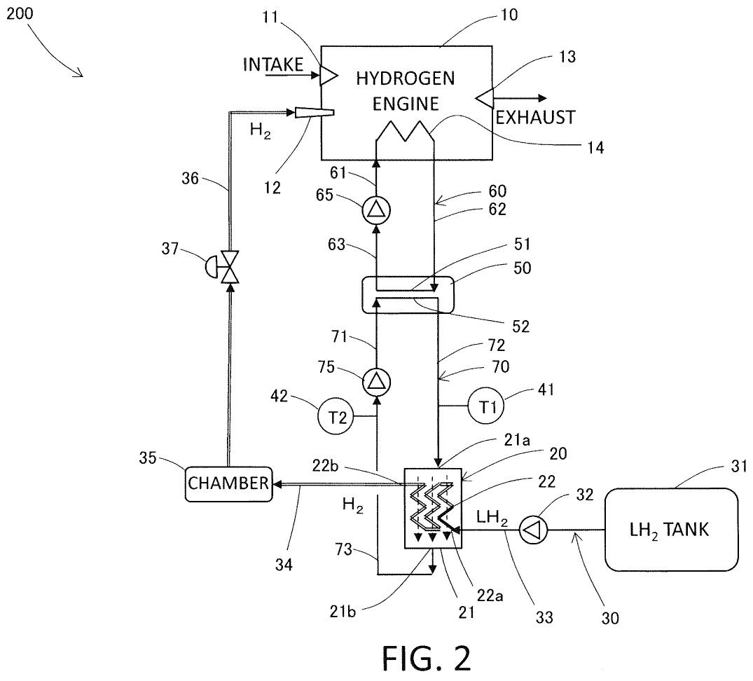

Next, a hydrogen engine system 200 of another embodiment will be described with reference to FIG. 2. Elements similar to those of the hydrogen engine system 100 described above with reference to FIG. 1 are denoted by the same reference numerals and characters, and repeated description thereof is omitted.

As shown in FIG. 2, the hydrogen engine system 200 includes a hydrogen engine 10, a vaporizer 20, a heat exchanger 50, a first cooling channel 60, a second cooling channel 70, and a hydrogen channel 30. The following describes the first cooling channel 60, the second cooling channel 70, and the heat exchanger 50. Since the hydrogen engine 10 and the hydrogen channel 30 have the same configuration as the hydrogen engine system 100 described above, repeated description thereof will be omitted.

The first cooling channel 60 is a channel through which a liquid first heat medium that cools the hydrogen engine 10 flows. The second cooling channel 70 is a channel through which a liquid second heat medium different from the first heat medium flows. The heat exchanger 50 includes a first heat medium channel 51 through which the first heat medium flows, and a second heat medium channel 52 through which the second heat medium flows. The heat exchanger 50 is disposed across the first cooling channel 60 and the second cooling channel 70, and causes the high-temperature first heat medium to heat the low-temperature second heat medium. The vaporizer 20, through which the second heat medium and liquid hydrogen flow, causes the second heat medium to vaporize the liquid hydrogen to generate hydrogen gas. The structure of the vaporizer 20 is the same as the structure of the vaporizer 20 of the hydrogen engine system 100 described above.

The first cooling channel 60 is composed of a first cooling water pump 65, a first heat medium supply pipe 61, an internal cooling channel 14, a first heat medium outlet pipe 62, the first heat medium channel 51, and a first heat medium return pipe 63. The first heat medium supply pipe 61 connects the outlet of the first cooling water pump 65 and the inlet of the internal cooling channel 14. The first heat medium outlet pipe 62 connects the outlet of the internal cooling channel 14 and the inlet of the first heat medium channel 51 of the heat exchanger 50. The first heat medium return pipe 63 connects the outlet of the first heat medium channel 51 and the inlet of the first cooling water pump 65.

The second cooling channel 70 is composed of a second cooling water pump 75, a second heat medium supply pipe 71, the second heat medium channel 52, a second heat medium outlet pipe 72, the vaporizer 20, and a second heat medium return pipe 73. The second heat medium supply pipe 71 connects the outlet of the second cooling water pump 75 and the inlet of the second heat medium channel 52. The second heat medium outlet pipe 72 connects the outlet of the second heat medium channel 52 and a heat medium inlet 21a of the vaporizer 20. The second heat medium return pipe 73 connects a heat medium outlet 21b of the vaporizer 20 and the inlet of the second cooling water pump 75.

The following describes the flow of the first heat medium, the second heat medium, liquid hydrogen, and hydrogen gas in the hydrogen engine system 200.

The low-temperature first heat medium is pressurized by the first cooling water pump 65 and flows through the first heat medium supply pipe 61 into the internal cooling channel 14 of the hydrogen engine 10. The first heat medium is heated by the combustion heat of the hydrogen engine 10, becomes a high-temperature first heat medium, and flows out to the first heat medium outlet pipe 62. The high-temperature first heat medium then flows from the first heat medium outlet pipe 62 into the first heat medium channel 51 of the heat exchanger 50. The first heat medium exchanges heat with the low-temperature second heat medium in the heat exchanger 50, to have a low temperature. The first heat medium then flows out from the first heat medium channel 51, flows into the first cooling water pump 65, is pressurized by the first cooling water pump 65, and circulates through the first cooling channel 60.

The low-temperature second heat medium is pressurized by the second cooling water pump 75 and flows through the second heat medium supply pipe 71 into the second heat medium channel 52 of the heat exchanger 50. The second heat medium exchanges heat with the high-temperature first heat medium in the heat exchanger 50, to have a high temperature. The second heat medium then flows out from the second heat medium channel 52 to the second heat medium outlet pipe 72. The high-temperature second heat medium flows through the second heat medium outlet pipe 72, and flows into a casing 21 of the vaporizer 20 from the heat medium inlet 21a of the vaporizer 20.

Meanwhile, the extremely-low-temperature liquid hydrogen, which has been stored in the liquid hydrogen tank 31, is pressurized by a liquid hydrogen pump 32 and flows from a liquid hydrogen supply pipe 33 into a coil inlet 22a of the vaporizer 20. The high-temperature second heat medium, which has flowed into the casing 21, flows on the outer surface of a coil 22. The extremely-low-temperature liquid hydrogen flows inside the coil 22. The high-temperature second heat medium and liquid hydrogen exchange heat through the coil 22. The liquid hydrogen is then vaporized into hydrogen gas, and the hydrogen gas flows out from a coil outlet 22b of the vaporizer 20 to a hydrogen gas outlet pipe 34. The high-temperature second heat medium exchanges heat with the extremely-low-temperature liquid hydrogen in the coil 22 to become the low-temperature second heat medium, and flows out from the heat medium outlet 21b to the second heat medium return pipe 73.

The low-temperature second heat medium, which has flowed out to the second heat medium return pipe 73, flows into the second cooling water pump 75, is pressurized by the second cooling water pump 75, and circulates through the second cooling channel 70.

Meanwhile, the high-pressure hydrogen gas, which has flowed out to a hydrogen gas outlet pipe 34, passes through a chamber 35 and a pressure reducing valve 37, and is supplied from the hydrogen gas nozzle 12 to the combustion chamber (not shown) of the hydrogen engine 10. Exhaust gas after combusting in the combustion chamber of the hydrogen engine 10 is discharged from the exhaust port 13 to outside air.

In the hydrogen engine system 200, the first heat medium and the second heat medium to be used may be water or LLC (long life coolant).

The hydrogen engine system 200 described above causes a liquid first refrigerant to heat a liquid second refrigerant in the heat exchanger 50, enabling the heat exchanger 50 to be compact. Further, heat exchange is performed between a liquid second heat medium and liquid hydrogen or hydrogen gas through the coil 22. This increases the heat exchange efficiency between the second heat medium and the liquid hydrogen or the hydrogen gas, enabling the vaporizer 20 to be compact. This in turn enables the hydrogen engine system 200 to be compact.

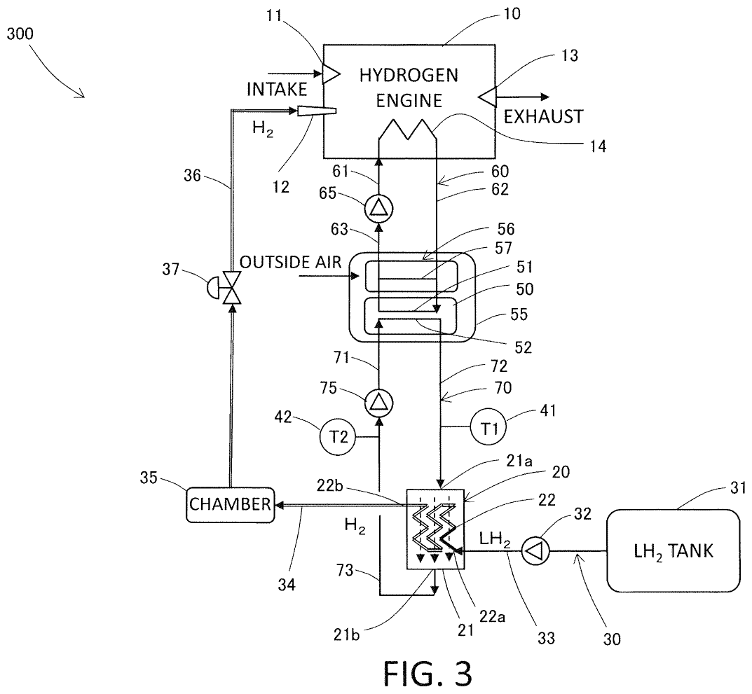

Next, a hydrogen engine system 300 of another embodiment will be described with reference to FIG. 3. As shown in FIG. 3, the hydrogen engine system 300 includes a radiator 56 that cools a first heat medium in a first cooling channel 60. The configuration other than the radiator 56 is the same as that of the hydrogen engine system 200 described above.

The radiator 56 cools the first heat medium, which has passed through an internal cooling channel 14 of a hydrogen engine 10 and has a high temperature. The radiator 56 is an air-cooled cooler that: internally includes an internal channel 57 through which the first heat medium flows; and has outside air flowing outside thereof.

The hydrogen engine system 300 can sufficiently cool the hydrogen engine 10 when the temperature of the hydrogen engine 10 rises and a large cooling capacity is required.

This enables the output of the hydrogen engine 10 to be kept high.

In the hydrogen engine system 300 described above, a heat exchanger 50 includes a first heat medium channel 51 and a second heat medium channel 52, and the radiator 56 and the heat exchanger 50 are separate devices. However, the configuration is not limited to this. For example, the configuration may be such that the heat exchanger 50: includes only the second heat medium channel 52; and heats a second heat medium with the air that has passed through the radiator 56 and has an increased temperature. Alternatively, the configuration may be such that the outer surface of the second heat medium channel 52 is in contact with the outer surface of the radiator 56, so that heat conduction from the outer surface of the radiator 56 heats the second heat medium.

1. A hydrogen engine system, comprising:
a hydrogen engine;
a cooling channel through which a liquid heat medium that cools the hydrogen engine flows; and
a vaporizer, disposed in the cooling channel, through which the heat medium and liquid hydrogen flow, the vaporizer causing the heat medium to vaporize the liquid hydrogen to generate hydrogen gas.

2. The hydrogen engine system according to claim 1, wherein the heat medium is LLC or water.

3. The hydrogen engine system according to claim 2, wherein a flow velocity of the heat medium inside the vaporizer is 26 mm/s or more.

4. The hydrogen engine system according to claim 2, wherein a temperature difference of the heat medium between an inlet and an outlet of the vaporizer is 10° C. or less.

5. The hydrogen engine system according to claim 1, wherein
the cooling channel is composed of: a first cooling channel through which a liquid first heat medium that cools the hydrogen engine flows; and a second cooling channel through which a second heat medium different from the first heat medium flows,
the hydrogen engine system includes a heat exchanger, disposed across the first cooling channel and the second cooling channel, through which the first heat medium and the second heat medium flow, the heat exchanger causing the first heat medium to heat the second heat medium, and
the vaporizer, through which the second heat medium and the liquid hydrogen flow, causes the second heat medium to vaporize the liquid hydrogen to generate the hydrogen gas.

6. The hydrogen engine system according to claim 5,
further comprising a cooler that cools the first heat medium,
wherein the first heat medium and the second heat medium are LLC or water.
